(19) United States
(12) Patent Application Publication
(10) Pub. No.: US 2024/0422682 A1
(43) Pub. Date: Dec. 19, 2024

(54) WIRELESS RECEIVER DEVICE, DATA PROCESSING METHOD THEREOF, AND WIRELESS COMMUNICATION SYSTEM

(71) Applicant: Realtek Semiconductor Corporation, Hsinchu (TW)

(72) Inventors: Chi-Mao LEE, Hsinchu (TW); Hsin-Yu KUO, Hsinchu (TW); Hsin-Chih HUANG, Hsinchu (TW)

(21) Appl. No.: 18/741,775

(22) Filed: Jun. 13, 2024

(30) Foreign Application Priority Data
Jun. 17, 2023 (TW) 112122827

(51) Int. Cl. H04W 52/02

(52) U.S. Cl. CPC H04W 52/0235; H04W 52/0229

(57) ABSTRACT

A wireless receiver device includes a decoder, a memory, and a processor. The decoder is configured to decode an aggregated packet in a period of plural symbols to obtain raw data, in which the aggregated packet includes plural subblocks. The memory is configured to temporarily store the raw data. The processor is configured to determine at least one non-idle symbol and at least one idle symbol from the symbol according to the number of symbols, the numbers of data bits per symbol respectively corresponding to the subblocks, and a performance characteristic of the processor. The processor accesses the memory to perform data parsing on the raw data in a period of the non-idle symbol, but enters an idle state so as not to access the memory in a period of the idle symbol.

### RELATED APPLICATIONS

This application claims priority to Taiwan Application Serial Number 112122827, filed Jun. 17, 2023, which is herein incorporated by reference.

### BACKGROUND

### Technical Field

The present disclosure relates to decoding and parsing of received packets, and more particularly to a wireless receiver device, a data processing method thereof, and a wireless communication system.

### Description of Related Art

For wireless communications, a transmission end usually performs encoding on raw data to form a packet, and then a receiving end performs decoding on the packet to restore the raw data. Usually, when receiving a packet, a decoder decodes the packet to obtain raw data and writes the raw data to a memory; then a processor accesses the memory to obtain the raw data, and performs data parsing on the raw data. Under a condition in which the occurrence of memory writing events cannot be predicted, the processor needs to continuously access the memory to obtain the decoded raw data and cannot perform another task, resulting in work efficiency degradation and significant power consumption. Therefore, how to optimize the power consumption performance of wireless communication devices in processing received packets is one of the main goals in related industries.

### SUMMARY

One aspect of the present disclosure directs to a wireless receiver device which includes a decoder, a memory, and a processor. The decoder is configured to decode an aggregated packet in a period of plural symbols to obtain raw data, in which the aggregated packet includes plural subblocks. The memory is configured to temporarily store the raw data. The processor is configured to determine at least one non-idle symbol and at least one idle symbol from the symbols according to the number of symbols, the numbers of data bits per symbol respectively corresponding to the subblocks, and a performance characteristic of the processor. The processor accesses the memory to perform data parsing on the raw data in a period of the at least one non-idle symbol, and enters an idle state so as not to access the memory in a period of the at least one idle symbol.

Another aspect of the present disclosure directs to a data processing method which is adapted to a wireless receiver device and includes: decoding an aggregated packet in a period of plural symbols to obtain raw data, in which the aggregated packet includes plural subblocks; temporarily storing the raw data to a memory; and determining at least one non-idle symbol and at least one idle symbol from the symbols according to the number of symbols, the numbers of data bits per symbol respectively corresponding to the subblocks, and a performance characteristic of the processor, and accessing the memory to perform data parsing on the raw data in a period of the at least one non-idle symbol, and entering an idle state so as not to access the memory in a period of the at least one idle symbol.

Yet another aspect of the present disclosure directs to a wireless communication system which includes a wireless transmitter device and a wireless receiver device, in which the wireless transmitter device is configured to transmit a packet, and the wireless receiver device is configured to receive the packet via a wireless channel. The wireless receiver device includes a decoder, a memory, and a processor. The decoder is configured to decode an aggregated packet in a period of plural symbols to obtain raw data, in which the aggregated packet includes plural subblocks. The memory is configured to temporarily store the raw data. The processor is configured to determine at least one non-idle symbol and at least one idle symbol from the symbols according to the number of symbols, the numbers of data bits per symbol respectively corresponding to the subblocks, and a performance characteristic of the processor. The processor accesses the memory to perform data parsing on the raw data in a period of the at least one non-idle symbol, and enters an idle state so as not to access the memory in a period of the at least one idle symbol.

### BRIEF DESCRIPTION OF THE DRAWINGS

The foregoing aspects and many of the accompanying advantages of the present disclosure will become more readily appreciated as the same becomes better understood by reference to the following detailed description, when taken in conjunction with the accompanying drawings.

FIG. 1 is a schematic diagram of a wireless communication system in accordance with some embodiment of the present disclosure.

FIG. 2 is a circuit block diagram of a wireless receiver device in accordance with some embodiment of the present disclosure.

FIG. 3 is an example of performing a packet decoding process using the wireless receiver device in FIG. 2.

FIG. 4 is a schematic flowchart of a method of counting the number of raw data strings per symbol in accordance with some embodiments of the present disclosure.

FIGS. 5A and 5B are examples of the status of a processor at different numbers of data bits per symbol and the same number of symbols.

FIG. 6 shows a statistical table of the number of raw data strings corresponding to a particular number of symbols and the numbers of data bits per symbol.

FIG. 7 is a schematic flowchart of an aggregated symbol category determination method in accordance with some embodiments of the present disclosure.

FIGS. 8A and 8B are aggregated symbol category tables for different processor performances according to an example of the present disclosure.

FIG. 9 is a schematic flowchart of a data processing method in accordance with some embodiment of the present disclosure.

FIGS. 10A and 10B are aggregated symbol category tables for different processor performances according to a first comparative example.

FIGS. 11A and 11B are aggregated symbol category tables for different processor performances according to a second comparative example.

### DETAILED DESCRIPTION

The detailed explanation of the present disclosure is described as following. The described preferred embodiments are presented for purposes of illustrations and description, and they are not intended to limit the scope of the present disclosure.

According to the current Wi-Fi system specifications, the transmission modes adopted in the Wi-Fi system may include orthogonal frequency division multiplexing (OFDM) transmission modes, High Throughput (HT) modes, Very High Throughput (VHT) modes, High Efficiency (HE) modes, and Extremely High Throughput (EHT) modes, in which the HT modes, the VHT modes, the HE modes, and the EHT modes respectively correspond to various generations of wireless local area networks (WLANs) such as Wi-Fi 4, Wi-Fi 5, Wi-Fi 6, and Wi-Fi 7. More transmission modes are usable for a wireless transceiver device if the hardware specification thereof is better and the Wi-Fi system supported thereby is more advanced. The embodiments of the present disclosure may also be applied to other wired and/or wireless communication technologies such as cellular network, Bluetooth, local area network (LAN) and/or Universal Serial Bus (USB).

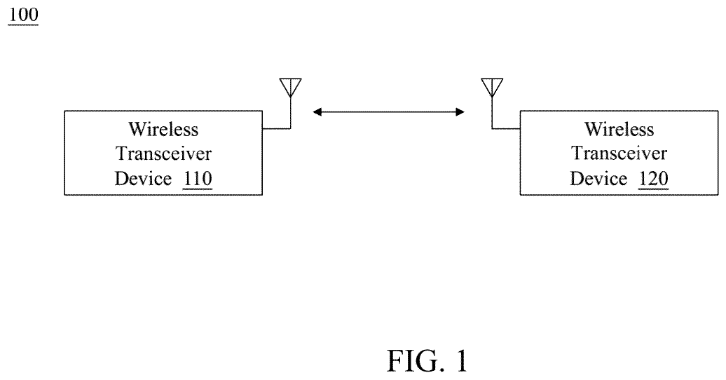

FIG. 1 is a schematic diagram of a wireless communication system 100 in accordance with some embodiment of the present disclosure. The communication technology applied in the wireless communication system 100 may be, for example, a wireless area network communication technology in accordance with the IEEE 802.11 standard (including IEEE 802.11ac, IEEE 802.11ax, IEEE 802.11be, etc.), and/or another applicable wireless communication technology. The wireless communication system 100 includes wireless transceiver devices 110 and 120 which are communicatively connected via a wireless channel. The wireless transceiver devices 110 and 120 may have functions of transmitting and receiving data packets. For example, in a scenario where the wireless transceiver device 110 transmits packets to the wireless transceiver device 120 via the wireless channel, the wireless transceiver devices 110 and 120 may also be referred to as a wireless transmitter device and a wireless receiver device, respectively.

The wireless channel in the wireless communication system 100 may support multiple-input multiple-output (MIMO), multiple-input single-output (MISO), single-input multiple-output (SIMO), and/or single-input single-output (SISO) transmissions between the wireless transceiver devices 110 and 120. Each of the wireless transceiver devices 110 and 120 may represent a variety of different implementations, including but not limited to mobile wireless transceiver devices such as stations (STAs), laptops, mobile phones, tablet computers, and access points (APs), and/or fixed wireless transceiver devices such as routers, switches, computer devices, server devices, and workstations.

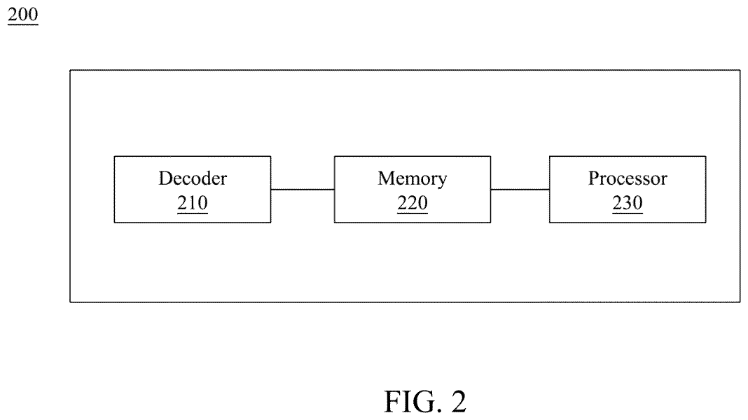

FIG. 2 is a schematic block diagram of a wireless receiver device 200 in accordance with some embodiments of the present disclosure. The wireless receiver device 200 may be the wireless transceiver device 110 and/or the wireless transceiver device 120 in FIG. 1. The wireless receiver device 200 includes a decoder 210, a memory 220 and a processor 230. The decoder 210 is configured to decode a received packet to obtain raw data. According to the coding technology applied in the wireless communication system, the decoder 210 may be, for example, a convolutional decoder, a trellis decoder, a Viterbi decoder, and/or a turbo decoder, but is not limited thereto. For example, if the wireless receiver device 200 is used in a WLAN communication system, the decoder 210 may be a Viterbi decoder.

The memory 220 is coupled to decoder 210, which may be configured to temporarily store the raw data obtained after decoding the packet by the decoder 210. The memory 220 may be a data memory (DMEM), a static random access memory (SRAM), or another memory suitable for temporarily storing the raw data.

The processor 230 is coupled to the memory 220, which may access the memory 220 to obtain the raw data temporarily stored in the memory 220, and may perform data parsing on the obtained raw data. The processor 230 may be, for example, a conventional processor, a multi-core processor, a digital signal processor (DSP), a microprocessor, or an application-specific integrated circuit (ASIC), but is not limited thereto.

The decoder 210 decodes the packet to obtain the raw data during plural symbols. Specifically, during each symbol, the decoder 210 decodes a corresponding segment in the packet to obtain the raw data in the number of data bits per symbol NDBPS. When the number of remaining bits rest_bits of the raw data decoded by the decoder 210 and not yet written to the memory 220 is greater than the bit number threshold T_{bits}, the decoder 210 may write a part of the raw data to the memory 220 for the processor 230 to perform data parsing. In particular, according to performance characteristic(s) of the processor 230 (such as clock rate), when the number of remaining bits rest_bits of the raw data is greater than the bit number threshold T_{bits} for the first time, the decoder 210 writes one K-bit source data string to the memory 220. Then, before the last symbol, as long as the number of remaining bits rest_bits of the raw data increases to be greater than the bit number threshold T_{bits} for other than the first time, the decoder 210 writes two K-bit source data strings to the memory 220. During the last symbol, the decoder 210 writes all raw data not yet written to the memory 220 to the memory 220.

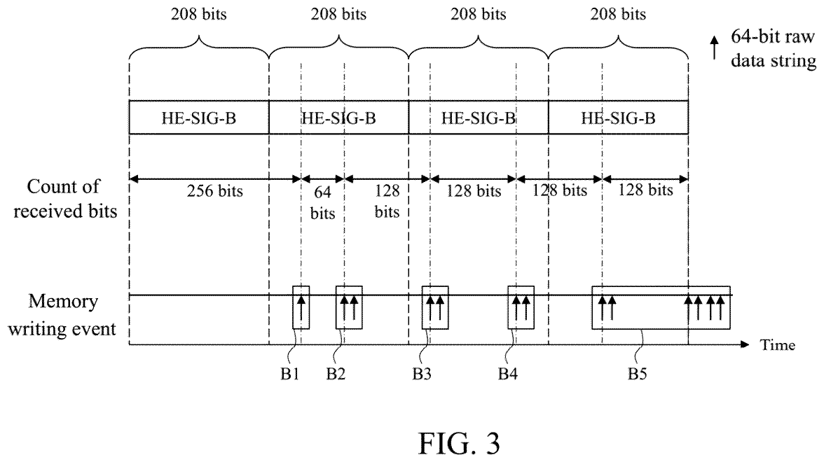

FIG. 3 is an example of packet decoding using the wireless receiver device 200 in FIG. 2. In this example, the wireless receiver device 200 is in an IEEE 802.11ax wireless area network to receive and decode a packet with a multi-user physical layer protocol data unit (HE MU PPDU) format and a modulation and coding scheme (MCS) index of 5, and the decoder 210 performs Viterbi decoding on a HE-SIG-B field in the received packet and writes to the memory 220 in 64-bit strings, in which the HE-SIG-B field corresponds to four orthogonal frequency division multiplexing (OFDM) symbols (hereinafter referred to as OFDM symbols). During the first OFDM symbol, the decoder 210 decodes the first segment of the HE-SIG-B field in the packet. The number of remaining bits rest_bits of the raw data increases to 208 and does not exceed 256, and therefore the decoder 210 does not write any 64-bit raw data string to the memory 220, i.e., no data write event occurs in the memory 220. During the second OFDM symbol, the decoder 210 decodes the second segment of the HE-SIG-B field in the packet, such that the number of remaining bits rest_bits increases to 416 that exceeds 256, and therefore the decoder 210 writes a 64-bit raw data string to the memory 220 (as shown in an arrow in Block B1). After writing a 64-bit raw data string, the number of remaining bits rest_bits decreases to 352 that still exceeds 256, and thus the decoder 210 then writes two more 64-bit raw data strings to the memory 220 (as shown in two arrows in Block B2). During the third OFDM symbol, the decoder 210 decodes the third segment of the HE-SIG-B field in the packet, such that the number of remaining bits rest_bits increases to 432 that exceeds 256, and thus the decoder 210 writes two 64-bit raw data strings to the memory 220 (as shown in two arrows in block B3). After writing two 64-bit raw data strings, the number of remaining bits rest_bits is 304 that still exceeds 256, and thus the decoder 210 then writes two more 64-bit raw data strings to the memory 220 (as shown in two arrows in block B4). During the fourth OFDM symbol, the decoder 210 decodes the fourth segment of the HE-SIG-B field in the packet, and then the raw data with the number of remaining bits rest_bits of 384 are divided into six 64-bit source data strings to be written to the memory 220 (as shown in 6 arrows in block B5).

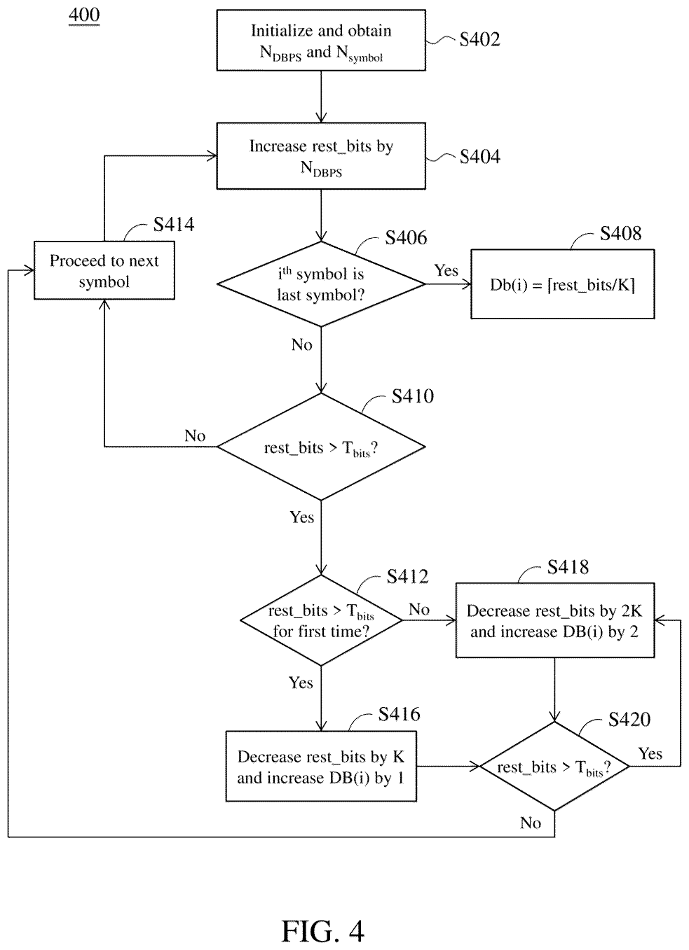

FIG. 4 is a schematic flowchart of a method of counting the number of raw data strings per symbol 400 in accordance with some embodiments of the present disclosure. The method of counting the number of raw data strings per symbol 400 may be used in the wireless receiver device 200 in FIG. 2 or another suitable wireless receiver device. For example, in an example of the wireless receiver device 200, the method of counting the number of raw data strings per symbol 400 may be performed by the processor 230.

In the method of counting the number of raw data strings per symbol 400, firstly Operation S402 is performed to obtain the number of data bits per symbol NDBPS and the number of symbols N_{symbol}, to initialize the number of remaining bits rest_bits as 0, to initialize all the numbers of raw data strings DB(1)-DB(N_{symbol}) respectively corresponding to 1^{st} to N_{symbol}^{th} symbols as 0, and to initialize a symbol sequence order i as 1. Next, Operation S404 is performed to increase the number of remaining bits rest_bits of the raw data by the number of data bits per symbol NDBPS. After that, Operation S406 is performed to determine whether the i^{th} symbol (i.e., the current symbol) is the last symbol, i.e., whether the symbol sequence order i is equal to the number of symbols N_{symbol}. If yes, Operation S408 is performed to record the number of raw data strings DB(i) corresponding to the i^{th} symbol as [rest_bits/K], and the method of counting the number of raw data strings per symbol 400, where [.] represents a ceiling function operation. Oppositely, if the current symbol is not the last symbol, Operation S410 is performed to determine whether the number of remaining bits rest_bits of the raw data is greater than the bit number threshold T_{bits}. If the determination result of Operation S410 is that the number of remaining bits rest_bits of the raw data is greater than the bit number threshold T_{bits}, Operation S412 is performed to further determine whether the number of remaining bits rest_bits of the raw data is greater than the bit number threshold T_{bits} for the first time. Oppositely, if the determination result of Operation S410 is that the number of remaining bits rest_bits of the raw data is not greater than the bit number threshold T_{bits}, Operation S414 is performed to proceed to the next symbol (i.e., the symbol sequence order i incremented by 1), and then return to Operation S404 for processing on the next symbol.

If the determination result of Operation S412 is that the number of remaining bits rest_bits of the raw data is greater than the threshold bits T_{bits} for the first time, Operation S416 is performed to subtract the number of remaining bits rest_bits of the raw data by the number of bits of one K-bit raw data string (i.e., rest_bits-K), and to increment the number of raw data strings DB(i) corresponding to the i^{th} symbol by 1. Oppositely, if the determination result of Operation S412 is that the number of remaining bits rest_bits of the raw data is not greater than the bit number threshold T_{bits} for the first time, then Operation S418 is performed to subtract the number of bits of two K-bit raw data strings from the number of remaining bits rest_bits of the raw data (i.e., rest_bits−2K), and to increment the number of raw data strings DB(i) corresponding to the i^{th} symbol by 2. After Operation S416 or S418 is completed, Operation S420 is performed to determine whether the number of remaining bits rest_bits of the raw data is greater than the bit threshold number T_{bits}. If the number of remaining bits rest_bits of the raw data is determined to be greater than the bit number threshold T_{bits}, Operation S418 is performed. Oppositely, if the number of remaining bits rest_bits of the raw data is determined not to be greater than the bit number threshold T_{bits}, Operation S414 is performed.

The bit number threshold T_{bits} and the number of bits K per raw data string in the method of counting the number of raw data strings per symbol 400 may be adjusted according to software and hardware specifications and/or communication system specifications. In some embodiments, the bit number threshold T_{bits} shall be greater than or equal to twice the number of bits K per raw data string, i.e., T_{bits}≥2K. In some embodiments, the bit number threshold T_{bits} and the number of bits K per raw data string are 256 and 64, respectively. In addition, some operations in the method of counting the number of raw data strings per symbol 400 also correspond to the operations of the decoder and the memory; Operation S404 corresponds to decoding the i^{th} HE-SIG-B packet by the decoder, Operation S408 corresponds to the event in which the decoder writes all remaining data to the memory at the end of the last symbol, Operation S416 corresponds to the event in which the decoder writes one K-bit raw data string to the memory, and Operation S418 corresponds to the event in which the decoder writes two K-bit raw data strings to the memory.

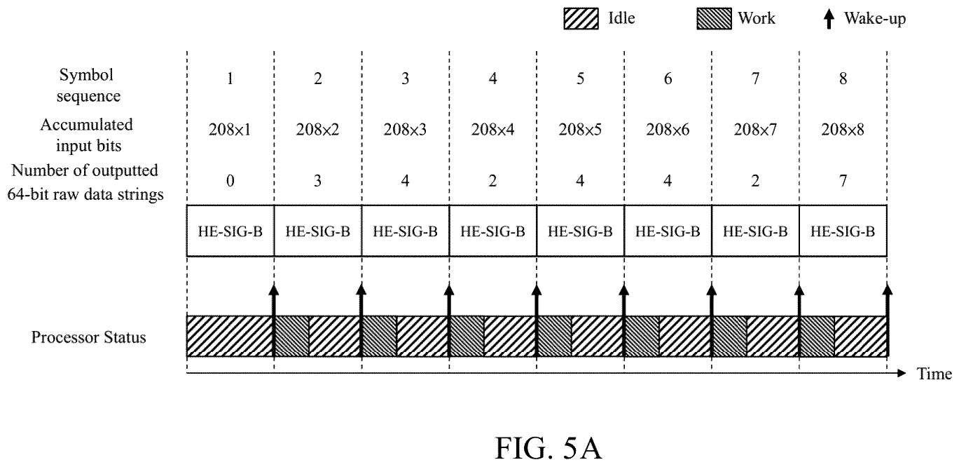

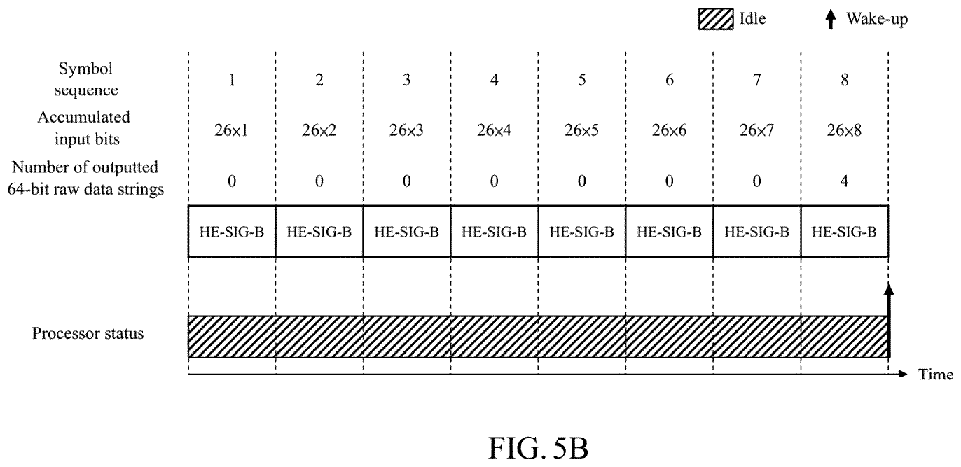

FIGS. 5A and 5B are examples of the status of the processor under different numbers of data bits per symbol NDBPS and the same number of symbols N_{symbol}, in which the bit number threshold T_{bits} and the number of bits K of the raw data strings are 256 and 64, respectively. In the example in FIG. 5A, the number of data bits per symbol NDBPS and the number of symbols N_{symbol} are 208 and 8, respectively. As can be seen from the content shown in FIG. 5A, during the period of the first symbol, the decoder does not write any 64-bit raw data string to the memory, and thus the processor wakes up to enter a wake-up state (e.g., a work state) to work during each of the 2^{nd} to 8^{th} symbols. In contrast, in the example in FIG. 5B, the number of data bits per symbol NDBPS and the number of symbols N_{symbol} are 28 and 8, respectively. As can be seen from the content shown in FIG. 5B, the decoder does not write any 64-bit raw data string to the memory during the period of the 1^{st} to 7^{th} symbols; during the 8^{th} symbol, the decoder writes all unwritten data strings to the memory, and thus the processor wakes up to enter the wake-up state only during the 8^{th} symbol.

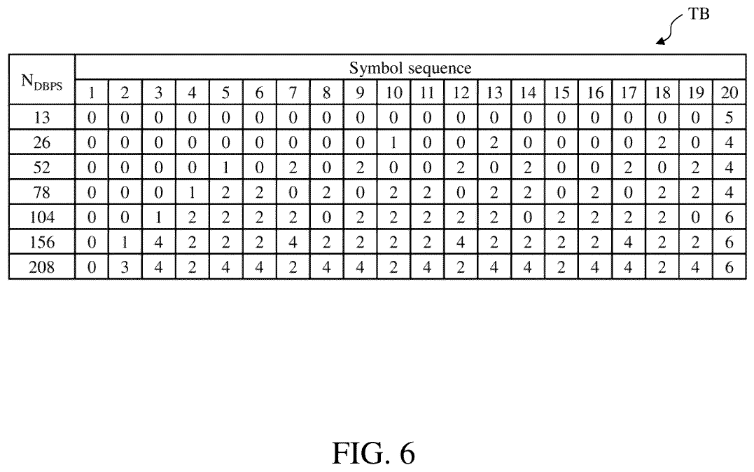

FIG. 6 shows a statistical table of the number of raw data strings TB corresponding to the number of symbols N_{symbol} (20) and the numbers of data bits per symbol NDBPS (13, 26, 52, 78, 104, 156, and 208). The statistical table of the number of raw data strings TB may be generated by performing the method of counting the number of raw data strings per symbol 400. Taking as an example in which the number of data bits per symbol NDBPS equals 104, the numbers of data bits per symbol during the period of the 3^{rd} and 4^{th} symbols are 1 and 2, respectively, representing that the decoder writes 1 and 2 raw data strings to the memory respectively during the period of the 3^{rd} and 4^{th} symbols.

In the IEEE 802.11be WLAN, aggregated downlink transmissions may be performed by using plural EHT-SIG content channels and plural subblocks. For example, a channel which a 320 MHz bandwidth has four subblocks, and each subblock has the number of data bits per symbol NDBPS that is determined from a modulation and coding scheme (MCS) index and dual-carrier modulation (DCM) configuration values (hereinafter DCM configuration values). The MCS index and the DCM configuration value corresponding to each subblock may be obtained from the U-SIG field in the EHT MU PPDU format.

Table 1 shows the relationship between the MCS index, the DCM configuration value, and the number of data bits per symbol NDBPS for each EHT-SIG field in the VHT MU PPDU. According to the content shown in Table 1, if the MCS index is 0, the numbers of data bits per symbol NDBPS corresponding to the DCM configuration values of 0 (i.e., DCM is not adopted) and 1 (DCM is adopted) are 13 and 26, respectively. The numbers of data bits per symbol NDBPS corresponding to other MCS indices and DCM configuration values may be obtained from the content shown in Table 1.

TABLE 1

| MCS index | DCM configuration value | N_{DBPS} |
|---|---|---|
| 0 | 0 | 13 |
| | 1 | 26 |
| 1 | 0 | 26 |
| | 1 | 52 |
| 2 | 0 | 78 |
| 3 | 0 | 52 |
| | 1 | 104 |
| 4 | 0 | 78 |
| | 1 | 156 |
| 5 | 0 | 208 |

Further, the processor may determine the status of each aggregated symbol (a symbol aggregating plural subblocks) according to the performance characteristic(s) and the MCS indices and the DCM configuration values corresponding to the subblocks (i.e., the numbers of data bits per symbol NDBPS corresponding to the subblocks).

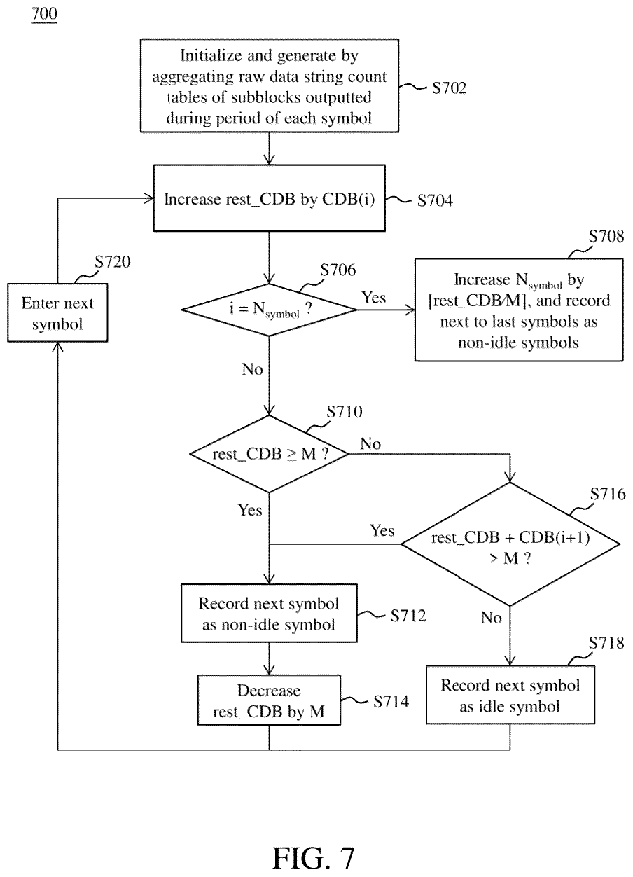

FIG. 7 is a schematic flowchart of an aggregated symbol category determination method 700 in accordance with some embodiments of the present disclosure. The aggregated symbol category determination method 700 may be used in the wireless receiver device 200 in FIG. 2 or another suitable wireless receiver device. For example, in an example of the wireless receiver device 200, the aggregated symbol category determination method 700 may be performed by the processor 230.

In the aggregated symbol category determination method 700, firstly Operation S702 is performed to aggregate raw data string count tables in the subblocks outputted during the period of each symbol to generate an aggregated raw data string count table outputted during the period of each aggregated symbol (in which the number of aggregated raw data strings CDB(i) is the sum of the numbers of raw data strings DB(i) in the subblocks), and to initialize the number of remaining aggregated raw data strings rest_CDB and the symbol sequence i as 0 and 1, respectively. Taking the statistical table of the number of raw data strings TB shown in FIG. 6 as an example, if 4 subblocks with the numbers of data bits per symbol NDBPS respectively of 26, 52, 78, and 104 are used to perform aggregated downlink transmissions, the raw data string count tables of these subblocks are the fields respectively corresponding to the numbers of data bits per symbol NDBPS of 26, 52, 78, and 104 in the statistical table of the number of raw data strings TB, and the aggregated raw data string count table is the sum of the abovementioned fields (for example, the numbers of raw data strings DB(5) of these 4 subblocks are 0, 1, 2, and 2, respectively, and the number of aggregated raw data strings CDB(5) in the aggregated raw data string count table is 0+1+2+2=5).

Then, Operation S704 is performed to increase the number of remaining aggregated raw data strings rest_CDB by the number of aggregated raw data strings CDB(i) of the current symbol (i.e., the i^{th} symbol). Thereafter, Operation S706 is performed to determine whether the current symbol is the last symbol, i.e., determine whether the symbol sequence i is equal to the symbol number N_{symbol}. If yes, Operation S708 is performed to increase the number of symbols N_{symbol} by [rest_CDB/M], and record the next symbol to the last symbol (the (N_{symbol}+ [rest_CDB/M])^{th} symbol) as non-idle symbols, and then the aggregated symbol category determination method 700 finishes, where M is a maximum number of raw data strings per symbol for process by the processor. Oppositely, if the current symbol is not the last symbol, Operation S710 is performed to determine whether the number of remaining aggregated raw data strings rest_CDB is greater than or equal to the maximum number of raw data strings per symbol for process M by the processor. If the determination result of Operation S710 is that the number of remaining aggregated raw data strings rest_CDB is greater than or equal to the maximum number of raw data strings per symbol for process by the processor M, Operation S712 is performed to record the next symbol (i.e., the (i+1)^{th} symbol) as a non-idle symbol, and Operation S714 is performed to decrease the number of remaining aggregated raw data strings rest_CDB by the maximum number of raw data strings per symbol for process by the processor M. Oppositely, if the determination result of Operation S710 is that the number of remaining aggregated raw data strings rest_CDB is less than the maximum number of raw data strings per symbol for process by the processor M, Operation S716 is performed to determine whether the sum of the number of remaining aggregated raw data strings rest_CDB and the number of aggregated raw data strings CDB(i+1) of the next symbol (i.e., the (i+1)^{th} symbol) is greater than the maximum number of raw data strings per symbol for process by the processor M. If it is determined that the sum of the number of remaining aggregated raw data strings rest_CDB and the number of aggregated raw data strings CDB(i+1) of the next symbol (i.e., the (i+1)^{th} symbol) is greater than the maximum number of raw data strings per symbol for process by the processor M, Operations S712 and S714 are performed. Oppositely, it is determined that the sum of the number of remaining aggregated raw data strings rest_CDB and the number of aggregated raw data strings CDB(i+1) of the next symbol (i.e., the (i+1)^{th} symbol) is not greater than the maximum number of raw data strings per symbol for process by the processor M, Operation S718 is performed to record the next symbol (i.e., the i+1^{th} symbol) as an idle symbol. After Operation S714 or S718 is completed, Operation S720 is performed to enter the next symbol (i.e., the symbol sequence i is incremented by 1), and return to Operation S704 for processing on the next symbol.

According to the present disclosure, the wireless receiver device 200 adopts the aggregated symbol category determination method 700 to obtain the category of each aggregated symbol, so as to accordingly determine the processor 230 to enter or keep in the idle state during the period of idle symbols and to enter or keep in the wake-up state during the period of non-idle symbols. Therefore, it can be ensured that the processor 230 with the maximum number of raw data strings per symbol for process M obtains at most M aggregated raw data strings of the raw data from the memory 220 during the period of each non-idle symbol when in the wake-up state, so as to use the shortest time to process on raw data, thereby achieving processing performance optimization.

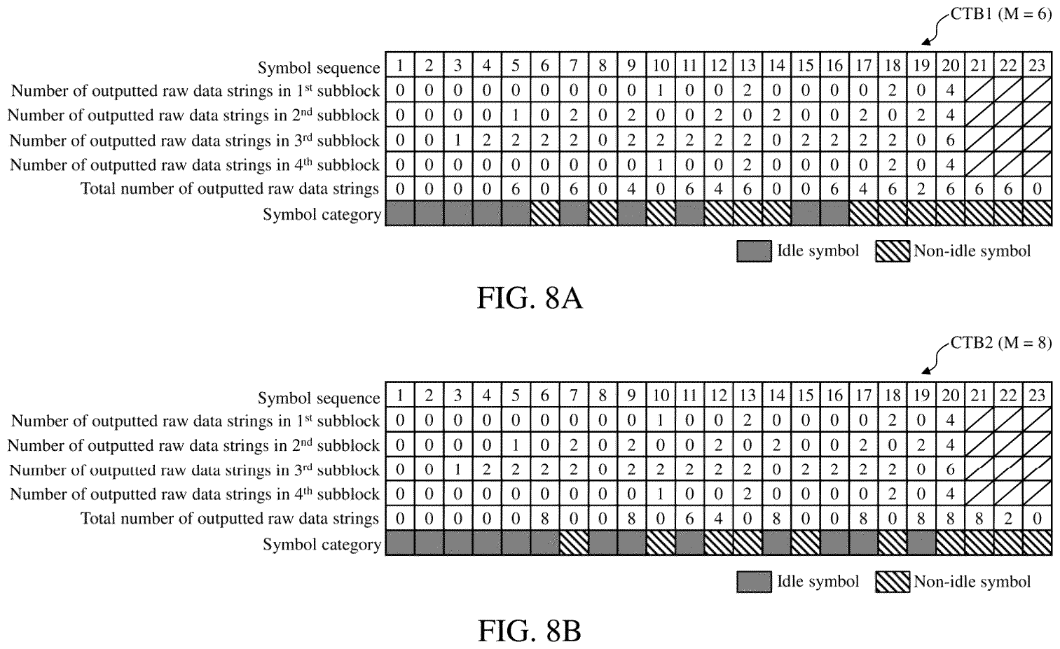

FIGS. 8A and 8B are aggregated symbol category tables CTB1 and CTB2 respectively corresponding to the maximum number of raw data strings per symbol for process M of 6 and 8 for a processor in a condition in which the numbers of data bits per symbol NDBPS of the 1^{st} to 4^{th} subblocks are respectively 26, 52, 104, and 52, the symbol number N_{symbol} is 20, and the bit number threshold T_{bits} and the number of bits K per raw data string are respectively 256 and 64, according to an example of the present disclosure. The numbers of outputted raw data strings of the 1^{st} to 4^{th} subblocks may be obtained by performing the method of counting the number of raw data strings per symbol 400, the total number of outputted raw data strings is the number of aggregated raw data strings per symbol, and the symbol categories may be obtained by performing the aggregated symbol category determination method 700. As shown in FIGS. 8A and 8B, in a condition of receiving the same aggregated packet, 10 of the 23 symbols in the aggregated symbol category table CTB1 are idle symbols, while 13 of the 23 symbols in the aggregated symbol category table CTB2 are idle symbols. That is, the processor with the maximum number of raw data strings per symbol for process M of 6 is in the idle state in 10 idle symbols, while the processor with the maximum number of raw data strings per symbol for process M of 8 is in the idle state in 13 idle symbols. Therefore, in a condition in which the processor performance is greater (the maximum number of raw data strings per symbol for process M is greater), the processor may be in the idle state for more times (i.e., the overall time in the idle state is longer), thus having batter power consumption performance.

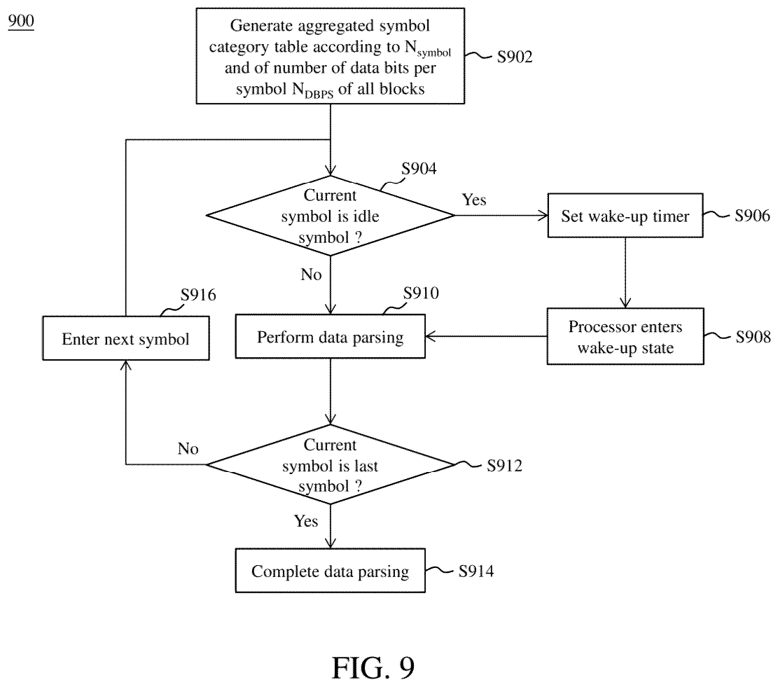

FIG. 9 is a flowchart of a data processing method 900 in accordance with some embodiments of the present disclosure. The data processing method 900 may be used in the wireless receiver device 200 in FIG. 2 or another suitable wireless receiver device. For example, in an example of the wireless receiver device 200, the data processing method 900 may be performed by the processor 230.

In the data processing method 900, firstly Operation S902 is performed to generate an aggregated symbol category table according to the performance of the processor, the number of symbols N_{symbol}, and the number of data bits per symbol NDBPS of all subblocks. The aggregated symbol category table may include category information whether each symbol is an idle symbol (i.e., an idle symbol or else a non-idle symbol). The aggregated symbol category table may be the aggregated symbol category table CTB1 shown in FIG. 8A or the aggregated symbol category table CTB2 shown in FIG. 8B, and may be obtaining by performing method of counting the number of raw data strings per symbol 400 and the aggregated symbol category determination method 700.

Then, Operation S904 is performed to determine whether the current symbol is an idle symbol according to the aggregated symbol category table. If yes, Operation S906 is performed to enter an idle state and set a wake-up timer according to the aggregated symbol category table (determine the time at which the processor wakes up from the idle state according to the sequence in which the next non-idle symbol appears). When the wake-up timer is timeout, Operation S908 is performed, in which the processor enters the wake-up state, and then Operation S910 is performed to access the memory to obtain the raw data strings to perform data parsing. Oppositely, if the determination result of Operation S904 is that the current symbol is a non-idle symbol, Operation S910 is performed directly. After Operation S910 is done, Operation S912 is performed to determine whether the current symbol is the last symbol according to the symbol state list. If the current symbol is determined to be the last symbol, Operation S914 is performed, in which the processor completes data parsing. Oppositely, if the current symbol is determined not to be the last symbol, Operation S916 is performed to enter the next symbol and return to Operation S904.

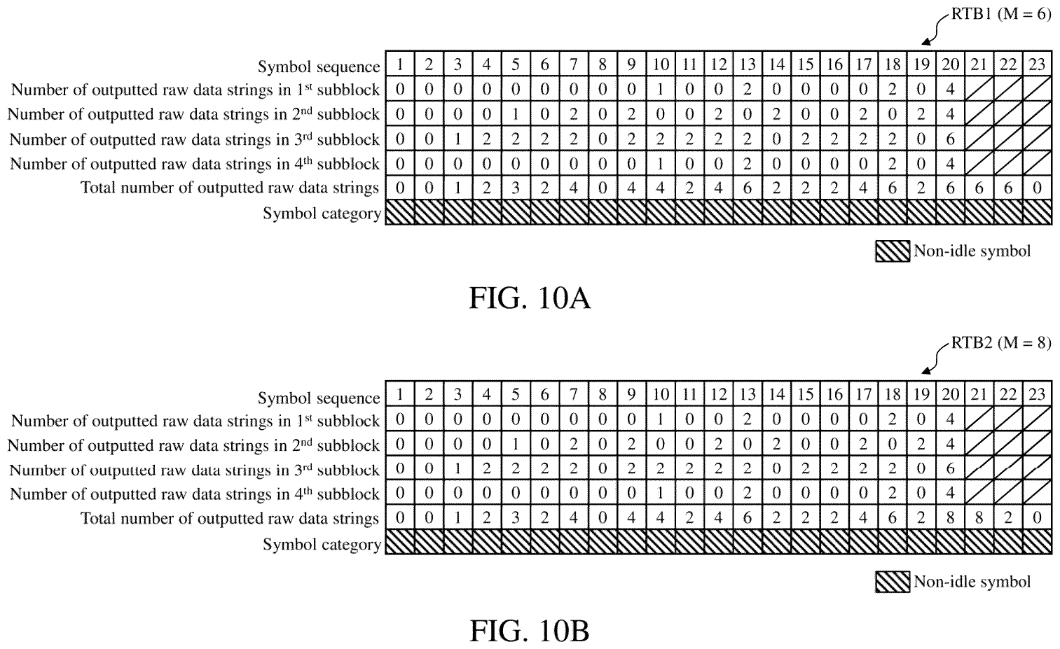

FIGS. 10A and 10B are aggregated symbol category tables RTB1 and RTB2 respectively corresponding to the maximum number of raw data strings per symbol for process M of 6 and 8 for a processor in a condition in which the numbers of data bits per symbol NDBPS of the 1^{st} to 4^{th} subblocks are respectively 26, 52, 104, and 52, the symbol number N_{symbol} is 20, and the bit number threshold T_{bits} and the number of bits K per raw data string are respectively 256 and 64, according to a first comparative example. The processor polls the memory to obtain the raw data temporarily stored in the memory during the period of each symbol. As shown in FIGS. 10A and 10B, in a polling mode, each symbol is a non-idle symbol and, therefore, regardless of whether there are any temporarily stored raw data in the memory and whether the performance of the processor is, the processor keeps in the wake-up state during the period of each symbol, which does not have any effect of power consumption reduction.

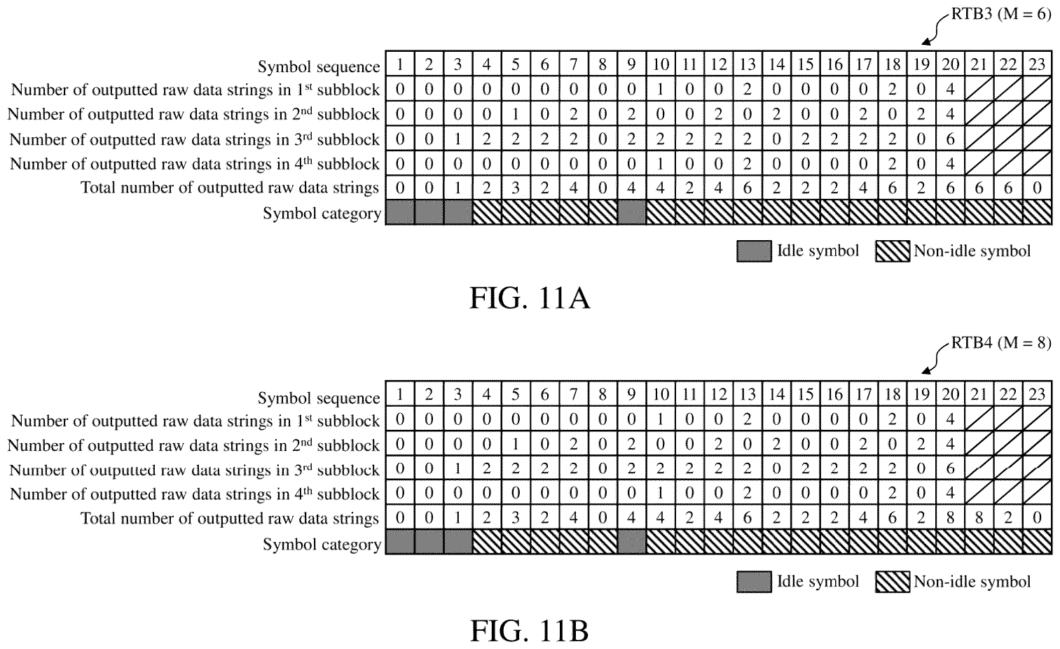

FIGS. 11A and 11B are aggregated symbol category tables RTB3 and RTB4 respectively corresponding to the maximum number of raw data strings per symbol for process M of 6 and 8 for a processor in a condition in which the numbers of data bits per symbol NDBPS of the 1^{st} to 4^{th} subblocks are respectively 26, 52, 104, and 52, the symbol number N_{symbol} is 20, and the bit number threshold T_{bits} and the number of bits K per raw data string are respectively 256 and 64, according to a second comparative example. In the second comparative example, the next symbol is a non-idle symbol if there is any outputted raw data string in any of the 1^{st} to 4^{th} subblocks during the period of the current symbol. Oppositely, the next symbol is an idle symbol if there is no outputted raw data string in the 1^{st} to 4^{th} subblocks during the period of the current symbol. That is, the processor determines to enter the wake-up state or the idle state according to whether there are raw data written to the memory during the period of each symbol. For example, as shown in FIG. 11A, the number of raw data strings written to the memory during the period of the 8^{th} symbol is 0, and thus the processor is in the idle state during the period of the 9^{th} symbol. The number of raw data strings written to the memory during the period of the 9^{th} symbol is 4 rather than 0, and thus the processor is in the wake-up state during the period of the 10^{th} symbol. As can be seen by comparing FIGS. 8A-8B and FIGS. 11A-11B, the processor according to the embodiments of the present disclosure can have more idle time, thereby achieving better power consumption performance.

As can be seen from the above description, in the present disclosure, the processors enter the wake-up state to access the memory and obtain raw data for data parsing process when the memory accumulates decoded raw data strings to a considerable number, and enters the idle state at other times, thereby improving the power consumption performance.

It will be apparent to those skilled in the art that various modifications and variations can be made to the structure of the present disclosure without departing from the scope or spirit of the present disclosure cover modifications and variations of this present disclosure provided they fall within the scope of the following claims.

What is claimed is:

1. A wireless receiver device, comprising:
a decoder configured to decode an aggregated packet to obtain raw data during a period of a plurality of symbols, the aggregated packet having a plurality of subblocks;
a memory configured to temporarily store the raw data; and
a processor configured to determine at least one non-idle symbol and at least one idle symbol from the plurality of symbols according to the number of symbols, the numbers of data bits per symbol respectively corresponding to the plurality of subblocks, and a performance characteristic of the processor;
wherein the processor accesses the memory to perform data parsing on the raw data in a period of the at least one non-idle symbol, and wherein the processor enters an idle state so as not to access the memory in a period of the at least one idle symbol.

2. The wireless receiver device of claim 1, wherein the decoder is a Viterbi decoder.

3. The wireless receiver device of claim 1, wherein the processor is configured to obtain at most M aggregated raw data strings in the raw data from the memory during a period of each of the at least one non-idle symbol, where M is a maximum number of raw data strings per symbol for process by the processor.

4. The wireless receiver device of claim 3, wherein the maximum number of raw data strings for processing by the processor per symbol is 6 or 8.

5. The wireless receiver device of claim 1, wherein the plurality of subblocks are 4 subblocks.

6. The wireless receiver device of claim 1, wherein the processor is configured to generate an aggregated symbol category table according to the performance characteristic, the numbers of data bits per symbol, and the number of symbols, and wherein the aggregated symbol category table comprises category information about whether each of the plurality of symbols is an idle symbol.

7. The wireless receiver device of claim 6, wherein the processor is configured to set a wake-up timer according to the aggregated symbol category table when entering the idle state, and wherein the processor enters a wake-up state when the wake-up timer is timeout.

8. A data processing method adapted to a wireless receiver device and comprising:
decoding an aggregated packet to obtain raw data during a period of a plurality of symbols, the aggregated packet having a plurality of subblocks;
temporarily storing the raw data to a memory of the wireless receiver device;
determine at least one non-idle symbol and at least one idle symbol from the plurality of symbols according to the number of symbols, the numbers of data bits per symbol respectively corresponding to the plurality of subblocks, and a performance characteristic of a processor of the wireless receiver device;
accessing the memory to perform data parsing on the raw data by the processor in a period of the at least one non-idle symbol; and
entering an idle state by the processor so as not to access the memory in a period of the at least one idle symbol.

9. The data processing method of claim 8, wherein accessing the memory to perform data parsing on the raw data by the processor in a period of the at least one non-idle symbol comprises:
obtaining at most M aggregated raw data strings in the raw data from the memory by the processor during a period of each of the at least one non-idle symbol, where M is a maximum number of raw data strings per symbol for process by the processor.

10. The data processing method of claim 9, wherein the maximum number of raw data strings for processing by the processor per symbol is 6 or 8.

11. The data processing method of claim 8, wherein the plurality of subblocks is 4 subblocks.

12. The data processing method of claim 8, further comprising:
generating an aggregated symbol category table according to the performance characteristic, the numbers of data bits per symbol, and the number of symbols, wherein the aggregated symbol category table comprises category information about whether each of the plurality of symbols is an idle symbol; and
setting a wake-up timer according to the aggregated symbol category table when entering the idle state, and entering a wake-up state when the wake-up timer is timeout.

13. A wireless communication system, comprising:
a wireless transmitter device configured to transmit an aggregated packet, the aggregated packet having a plurality of subblocks; and
a wireless receiver device configured to receive the aggregated packet via a wireless channel, the wireless receiver device comprising:
a decoder configured to decode the aggregated packet to obtain raw data during a period of a plurality of symbols;
a memory configured to temporarily store the raw data; and
a processor configured to determine at least one non-idle symbol and at least one idle symbol from the plurality of symbols according to the number of symbols, the numbers of data bits per symbol respectively corresponding to the plurality of subblocks, and a performance characteristic of the processor;
wherein the processor accesses the memory to perform data parsing on the raw data in a period of the at least one non-idle symbol, and wherein the processor enters an idle state so as not to access the memory in a period of the at least one idle symbol.

14. The wireless communication system of claim 13, wherein the aggregated packet comprises a packet with an Extremely High Throughput multi-user physical layer protocol data unit (EHT MU PPDU) format.

15. The wireless communication system of claim 13, wherein the decoder is a Viterbi decoder.

16. The wireless communication system of claim 13, wherein the processor is configured to obtain at most M aggregated raw data strings in the raw data from the memory during a period of each of the at least one non-idle symbol, where M is a maximum number of raw data strings per symbol for process by the processor.

17. The wireless communication system of claim 16, wherein the maximum number of raw data strings for processing by the processor per symbol is 6 or 8.

18. The wireless communication system of claim 13, wherein the plurality of subblocks is 4 subblocks.

19. The wireless communication system of claim 13, wherein the processor is configured to generate an aggregated symbol category table according to the performance characteristic, the numbers of data bits per symbol, and the number of symbols, and wherein the aggregated symbol category table comprises category information about whether each of the plurality of symbols is an idle symbol.

20. The wireless communication system of claim 19, wherein the processor is configured to set a wake-up timer according to the aggregated symbol category table when entering the idle state, and wherein the processor enters a wake-up state when the wake-up timer is timeout.
